(19) United States
(12) Patent Application Publication
(10) Pub. No.: US 2011/0155692 A1
(43) Pub. Date: Jun. 30, 2011

(54) METHOD OF FORMING PATTERNS

(76) Inventor: Tzong-Liang Yau, Tainan City (TW)

(21) Appl. No.: 12/649,339

(22) Filed: Dec. 30, 2009

(51) Int. Cl. B44C 1/22

(52) U.S. Cl. 216/41

(57) ABSTRACT

A method of forming a pattern includes: first, a material layer to be etched is provided. The material layer can be a dielectric layer within which wires are to be formed within. Next, a patterned hard mask is formed on the material layer. The material layer of the patterned hard mask can be single layer or multiple layers. For example, the patterned hard mask may include at least one metal-atom-containing layer. Then, a pretreatment comprising nitridation, oxidation or UV curing process which can transform the surface property of the at least metal-atom-containing layer is performed on the patterned hard mask. Therefore, the treated metal-atom-containing layer which is treated will not adversely react with the etchant gas. Finally, the dielectric material layer can be etched by taking the patterned hard mask as a mask.

### BACKGROUND OF THE INVENTION

1. Field of the Invention

The present invention relates to a method of forming patterns, more particularly to a method capable of forming patterns without reactants attaching on the hard mask.

2. Description of the Prior Art

The integrated circuit is fabricated in a layer process which includes these key process steps such as imaging, deposition, etching and doping etc. The imaging and etching includes forming a patterned photoresist on the material layer to be etched, and then etching the material layer by taking the patterned photoresist as a mask to transfer the pattern on the photoresist onto the material layer. However, due to the size of the integrated circuit being reduced, the resolution of the lithography system needs to be increased as well. One way to increase the resolution is to increase the numerical aperture. But the depth of focus will be compromised due to the increase of the numerical aperture. As the depth of focus is decreased, the patterned photoresistor becomes thinner. Therefore, most of the patterned photoresistor is etched during the etching process and the patterned photoresistor can not protect the material layer well.

Therefore, a hard mask is used to replace the photoresist because fewer hard masks will be consumed during the etching process. So an ideal pattern can be transferred onto the material layer. The hard mask can be a composite structure such as a silicon nitride, a silicon oxynitride, or a silicon oxide. FIG. 1 to FIG. 2 depict a conventional method of patterning the hard mask. As shown in FIG. 1, a material layer 10 to be etched is covered by a hard mask 12. The hard mask 12 includes a silicon oxide layer 14, a silicon oxynitride layer 16 and a silicon nitride layer 18 from bottom to top. Then, the lithography and etching process are used to form a patterned photoresist (not shown) on the hard mask 12. Next, the hard mask 12 is patterned and the patterned photoresist is removed afterwards. Finally, the patterned hard mask 20 as shown in FIG. 2 can be formed.

Each material layer has different properties. For example, each material layer has a different etching rate, and the etching residual of each material layer is different. Therefore, the profile of the patterned hard mask 20 will be uneven because of the different etching rates of each of the material layers and different etching residuals formed on each of the material layers. So the pattern of the patterned hard mask 20 can not be transferred onto the material layer 10 precisely.

### SUMMARY OF THE INVENTION

In light of above, one object of the present invention is to provide a method of forming patterns to solve the above-mentioned problems.

According to a preferred embodiment of the present invention, a method of forming patterns includes providing a material layer to be etched. The material layer can be an interlayer dielectric layer. Then, a patterned hard mask is formed on the material layer, wherein the patterned hard mask can be a single structure or a multiple layer structure. Next, a pretreatment process is performed on the patterned hard mask. The pretreatment process can be a nitridation process, an oxidation process or a radiation-related chemical reaction process. Finally, the patterned hard mask is used as a mask to etch the material layer.

According to a preferred embodiment of the present invention, the hard mask includes a silicon nitride layer, a silicon oxynitride layer, a titanium nitride layer, a titanium layer and combinations thereof. The titanium layer will become a titanium nitride layer after the nitridation process.

According to another preferred embodiment of the present invention, the distance between the two electrodes of the etching tool is between 26 millimeters to 33 millimeters.

According to another preferred embodiment of the present invention, the power of the etching tool is 50 watts or 150 watts.

According to another preferred embodiment, a carrier gas such as nitrogen is sent into the reaction chamber.

The feature of the present invention is that the surface property of the patterned hard mask is changed by a pretreatment process. Therefore, the patterned hard mask will not adversely react with the etchant during the etching process. The pattered hard mask will not deform, and etching residual will not clog on the hard mask and the material layer.

Another feature of the present invention is that there are a plurality of methods of preventing the deformation of the patterned hard mask which can be applied individually or in combination.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 2 depict a conventional method of patterning the hard mask.

FIG. 3 to FIG. 6 depict schematically a method of forming patterns according to the present invention.

FIG. 7 depicts a deformed patterned hard mask form by a conventional method.

FIG. 8 depicts a material layer with bowl-like profile formed by a conventional method.

### DETAILED DESCRIPTION

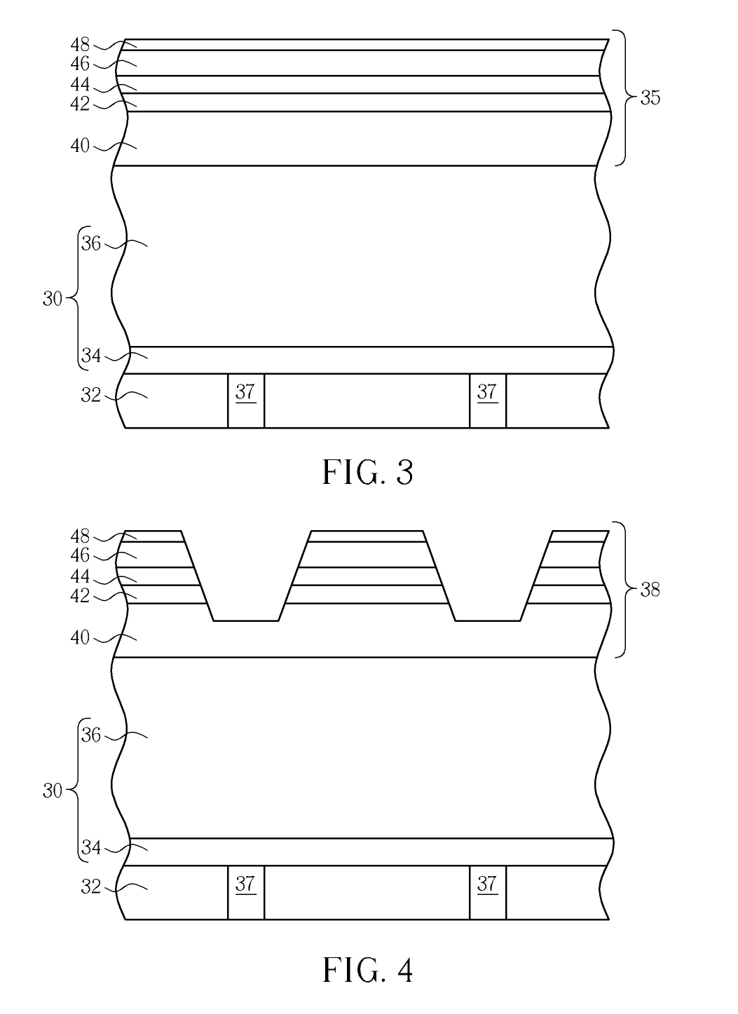

FIG. 3 to FIG. 6 depict schematically a method of forming patterns according to the present invention. As shown in FIG. 3, a material layer 30 to be etched is provided. The material layer 30 may include a dielectric layer 34, and a low-k dielectric layer 36. The material layer 30 is positioned on a metal interconnection layer 32, wherein a metal interconnection 37 is embedded in the metal interconnection layer 32. For example, the metal interconnection 37 can be a single damascene structure, a dual damascene structure, a contact plug or other conductive elements. Next, a hard mask 35 is formed on the on the material layer 30. The hard mask 35 can includes at least one metal-atom-containing material. For example, the hard mask 35 maybe a composite material consisting of a silicon oxynitrde layer 40, a titanium layer 42, a titanium nitride layer 44, a silicon oxynitrde layer 46 and a silicon oxide layer 48 disposed from bottom to top on the material layer 30. The silicon oxynitrde layer 40, titanium nitride layer 44, the silicon oxynitrde layer 46 and the silicon oxide layer 48 in the hard mask 35 can be formed optionally base on different requirements. Then, a patterned photoresist (not shown) is formed on the hard mask 35, and the silicon oxide layer 48, the silicon oxynitrde layer 46, the titanium nitride layer 44, the titanium layer 42 are etched through by taking the patterned photoresist as a mask to form a patterned hard mask 38 shown in FIG. 4. Later, the patterned photoresist is removed. It is noteworthy that the silicon oxide layer 48, the silicon oxynitrde layer 46, the titanium nitride layer 44, and the titanium layer 42 of the patterned hard mask 38 are etched through and the silicon oxynitride layer 40 of the patterned hard mask 38 is not etched through. Therefore, the dielectric layer 36 is still covered by the silicon oxynitride layer 40. Therefore, the dielectric layer 36 will be protected by the silicon oxynitride layer 40 when the patterned photoresist is removed. Moreover, based on the stress, the capability of the anti-reflective, the adhesion force, the capability of the anti-etching or other factors, the hard mask 35 may include the material layer such as the silicon oxynitrde layer 40, the titanium layer 42, the titanium nitride layer 44, the silicon oxynitrde layer 46 and the silicon oxide layer 48 mentioned above, but not limited to them, other suitable materials can also be used. Different combinations of the material layer in the hard mask 35 can provide different tensile or compressive stress. By selecting adequate material layers, excess force will not formed in the hard mask 35, and the delamination can be prevented. According to another preferred embodiment, the material layer 30 can include semiconductive materials, conductive materials or work function materials. The pattern to be formed on the material layer 30 can be a via, a trench, a strip or a bulky of pattern. The titanium layer 42 can be replaced by titanium, tantalum, lanthanum, rare earth elements, or transition elements. The titanium nitride layer 44 can be replaced by other metal nitrides or metal oxides, such as titanium nitride, aluminum oxide, or etc. Furthermore, the patterned hard mask 38 can further include an organic material such as photoresist. The patterned hard mask 38 may be a single layer or multilayer structure. For example, the patterned hard mask 38 can be made of only one metal layer such as a titanium layer. Moreover, the method of the present invention can be applied to any process needing a hard mask such as a gate formation or a dual damascene process. The embodiment as follows illustrates the method of forming patterns utilized in the interconnection formation. When the patterned hard mask 38 includes an organic material such as a photoresist, the method of forming the patterned hard mask 38 is by performing the exposure and development process to the hard mask 35. After the patterned hard mask 38 is formed the photoresist does not need to be removed.

As shown in FIG. 5, after the patterned hard mask 38 is formed, a pretreatment 50 such as a nitridation process is performed on the patterned hard mask 38 and the patterned hard mask 38 is transformed to form a patterned hard mask 38′. During the nitridation process, the surface of the patterned hard mask 38 is nitridized. In other words, the silicon oxynitride layer 40, the titanium layer 42, the titanium nitride layer 44, the silicon oxynitrde layer 46, and the silicon oxide layer 48 which are exposed in the space respectively are nitridized. It is noteworthy that the exposed surface of the titanium layer 42 and the exposed surface of the silicon oxynitride layer 40 are nitridized. Therefore, nitrides are formed on the side wall of the titanium layer 42 and on the side wall and horizontal surface of the silicon oxynitride layer 40 respectively. The nitridation process is performed by a plasma tool. During the nitridation process, the operation frequency is 2 MHz or 60 MHz and the operation time is 10 to 15 seconds.

As shown in FIG. 6, an etching process is performed by taking the patterned hard mask 38′ as a mask to etch the material layer 30 and to transfer the pattern on the patterned hard mask 38′ to the material layer 30. Because part of the patterned hard mask 38′ and the nitride on the patterned hard mask 38′ are also etched during the etching process, only part of the patterned hard mask 38′ remains in FIG. 6. The etching process can be performed in situ or ex situ after the pretreatment 50 is performed.

The pretreatment 50 is not limited to the nitridation process. The pretreatment 50 can be replaced by an oxidation process, a radiation-related chemical ration such as an UV curing process or other process capable of changing the surface property of the patterned hard mask 38. The aforesaid surface property can be a physical property or a chemical property. For example, the critical dimension of the patterned hard mask 38 can be reduced after the oxidation process. For another example, the bonding character may change after the UV curing process, and the patterned hard mask 38 can provide a better protection.

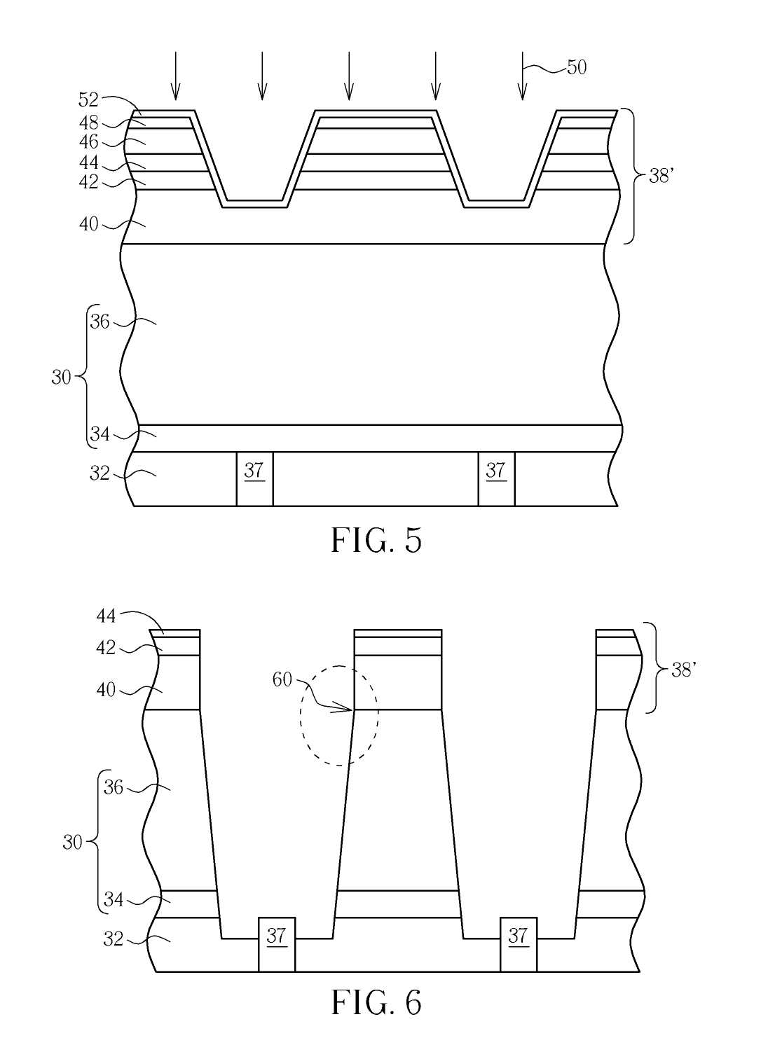

FIG. 7 depicts a deformed patterned hard mask form by a conventional method, wherein elements with the same function will be designated with the same numeral. A conventional plasma etching includes using the fluorocarbon as an etching. For example, the plasma etching can be performed by ionizing the fluorocarbon such as carbon tetrafluoride, trifluoromethane or hexafluoroethane and form plasma to etching the material layer. The plasma contains fluoride ions and fluorocarbon radicals. However, in the conventional method, the patterned hard mask does not undergo the pretreatment. Therefore, as shown in FIG. 7, when using the plasma to etch the material layer 30, the surface of the titanium layer 42 without pretreatment will react with the fluoride ions, and titanium fluoride bulge 54 will form on the surface of the titanium layer 42. Then, the etching residual such as fluorocarbon polymers 56 will clog on the surface of the patterned hard mask 38, leading to deformation of the patterned hard mask 38. Unlike the conventional method, the present invention transforms the surface of the titanium layer 42 to titanium nitride by the pretreatment process 50. Therefore, the titanium layer 42 will not react with the etchant, and the titanium fluoride bulge 54 will not be synthesized.

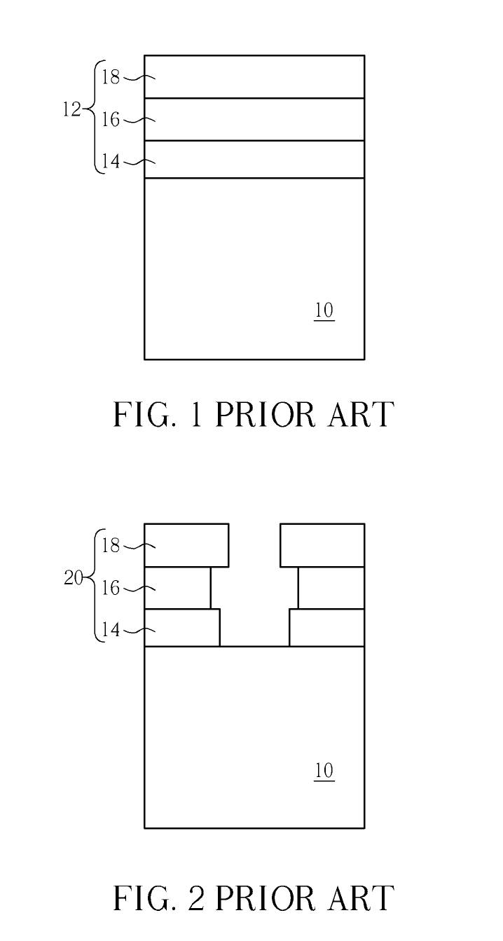

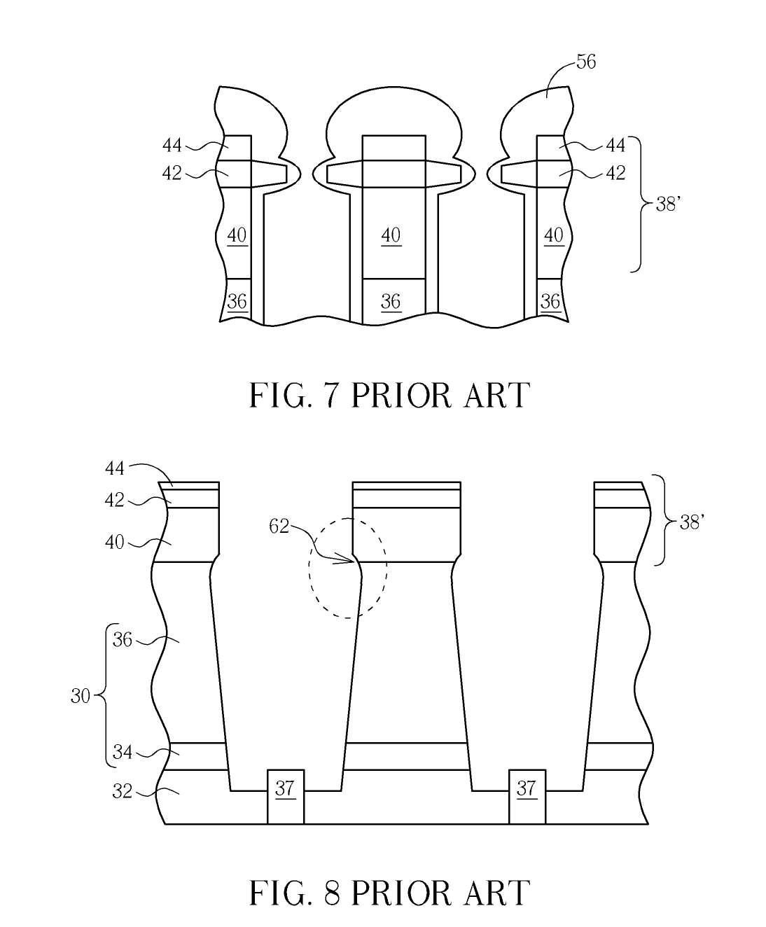

FIG. 8 depicts a material layer with bowl-like profile formed by a conventional method, wherein elements with the same function will be designated with the same numeral. In the conventional method, because the etching rate of the patterned hard mask and the material layer differ greatly, a bowl-like profile will be formed after the material layer is etched. Taking the pattered hard mask 38 composed of the silicon oxynitride layer 40, the titanium layer 42, the titanium nitride layer 44, the silicon oxynitrde layer 46, and the silicon oxide layer 48 shown in FIG. 1 as example, the etching rate of the silicon oxynitride layer 40 is smaller than the low-k dielectric layer 36. Therefore, during the etching process, the low-k dielectric layer 36 will be etched more than the oxynitride layer 40. So the bowl-like profile 62 shown in FIG. 8 marked by circle is formed. As shown in FIG. 5, in the present invention, the surface property of the patterned hard mask 38′ is changed. So the etching rate of the patterned hard mask 38′, especially the silicon oxynitride layer 40 is also changed. Therefore, etching rate of the silicon oxynitride layer 40 becomes nearer to the etching rate of the low-k dielectric layer 36, and a smooth profile 60 in the FIG. 5 is formed after the etching process.

Additionally, there are three methods to prevent the formation of the titanium fluoride bulge 54 provided in the present invention. The three methods include increasing the distance between the two electrodes of an etching tool, decreasing the operational power of the etching tool, and inputting carrier gas during the etching process. The reason for increasing the distance between the two electrodes of the etching tool or decreasing the operational power of the etching tool is to decrease the electric field between the two electrodes. When the electric field is decreased, the fluoride ions in the reaction chamber of the etching tool will be decreased as well. Therefore, there will be fewer fluoride ions to react with the titanium layer 42. Furthermore, the aforesaid carrier gas can be nitrogen, argon or helium. When inputting the carrier gas into the reaction chamber, the surface of the titanium layer 42 will react with the carrier gas such as titanium nitride, then the transformed titanium layer 42 will not react with the etchant. The titanium fluoride bulge 54 can be prevented. According to a preferred embodiment of the present invention, the distance between two electrodes of the etching tool is between 26 millimeters to 33 millimeters. The power of the etching tool is preferably 50 watts or 150 watts and the frequency of the etching tool is 2 MHz, 27 MHz or 60 MHz. The carrier gas is 20-50 sccm. The aforesaid three methods can be preformed individually, or be performed together. The aforesaid three methods can even be combined with the pretreatment process. For example, the pattered hard mask can be nitridized by the pretreatment process, and then the carrier gas can be inputted during the etching process. In this way, the titanium fluoride bulge can be prevented better.

Those skilled in the art will readily observe that numerous modifications and alterations of the device and method may be made while retaining the teachings of the invention.

What is claimed is:

1. A method of forming patterns, comprising:
providing a material layer covered by a patterned hard mask;
performing a pretreatment to transform the surface property of the patterned mask; and
after the pretreatment, patterning the material layer by taking the patterned hard mask as a mask.

2. The method of forming patterns of claim 1, wherein the pretreatment comprises a nitridation process, an oxidation process or a radiation-related chemical reaction process.

3. The method of forming patterns of claim 1, wherein the material layer comprises a semiconductive material.

4. The method of forming patterns of claim 1, wherein the material layer comprises a work function material.

5. The method of forming patterns of claim 1, wherein the patterned hard mask comprises a metal, a metal oxide or a metal nitride.

6. The method of forming patterns of claim 5, wherein the patterned hard mask further comprises a dielectric material.

7. The method of forming patterns of claim 5, wherein the patterned hard mask further comprises an organic material.

8. The method of forming patterns of claim 7, wherein the material layer is patterned in situ after the pretreatment is performed.

9. The method of forming patterns of claim 1, wherein one of the chemical property and the physical property of the patterned hard mask is changed after the pretreatment.

10. The method of forming patterns of claim 9, wherein the chemical property comprises the bonding character of the surface of the hard mask.

11. A method of forming patterns, comprising:
providing a material layer covered by a patterned hard mask comprising at least one metal-atom-containing material;
performing a pretreatment to transform the surface property of the patterned mask; and
after the pretreatment, performing an etching process to pattern the material layer by taking the patterned hard mask as a mask.

12. The method of forming patterns of claim 11, wherein the pretreatment comprises a nitridation process, an oxidation process or a radiation-related chemical reaction process.

13. The method of forming patterns of claim 12, wherein after the pretreatment, one of an oxide of the metal-atom-containing material and a nitride of the metal-atom-containing material is formed on the surface of the metal.

14. The method of forming patterns of claim 13, wherein the metal-atom-containing material is selected from the group consisting of titanium, titanium nitride, tantalum, lanthanum, rare earth elements, and transition elements.

15. The method of forming patterns of claim 11, wherein the etching process is performed in situ after the pretreatment is performed.

16. The method of forming patterns of claim 11, wherein the etching process is a plasma etching performed by using an etching tool.

17. The method of forming patterns of claim 16, wherein the distance between two electrodes of the etching tool is between 26 millimeters to 33 millimeters.

18. The method of forming patterns of claim 16, wherein the power of the etching tool is 50 watts or 150 watts and the frequency of the etching tool is 2 MHz, 27 Mhz or 60 Mhz.

19. The method of forming patterns of claim 11, wherein the etching process is performed with nitrogen flowing into the etching tool to serve as a carrier gas.

20. The method of forming patterns of claim 11, wherein the patterned hard mask comprises a silicon oxide layer, a silicon oxynitride layer, a titanium nitride layer and a titanium layer.
